(19) United States
(12) Patent Application Publication
(10) Pub. No.: US 2025/0018553 A1
(43) Pub. Date: Jan. 16, 2025

(54) MOVABLE SHELVING SYSTEM HAVING RETRACTABLE WHEELS

(71) Applicants: Nathaniel Bailey, Wildwood, GA (US); Leah Bailey, Wildwood, GA (US)

(72) Inventors: Nathaniel Bailey, Wildwood, GA (US); Leah Bailey, Wildwood, GA (US)

(21) Appl. No.: 18/350,068

(22) Filed: Jul. 11, 2023

(51) Int. Cl. B25H 3/02; B62B 5/04

(52) U.S. Cl. CPC B25H 3/028; B62B 5/04

(57) ABSTRACT

A movable shelving unit for moving over ground surfaces in two different modes of operation consisting of a shelving unit and a movable base. The movable base includes a first set of wheels and a second set of wheels, each set of wheels having a first position wherein none of the wheels comprising the wheelset contacts a ground surface and a second position wherein each of the wheels comprising the respective wheelset contacts the ground surface. The movable base also contains a mode selector for moving the various wheelsets between the first and second positions. A brake mechanism is included to reduce movement of a wheelset. The shelving unit can be collapsible to allow for easier transportation and storage. The first wheelset is for moving the shelving unit over rough ground surfaces and the second wheelset is for smooth ground surfaces.

### CROSS-REFERENCE TO RELATED APPLICATIONS

This application claims the benefit of U.S. Provisional Application No. 63/389,033 filed Jul. 14, 2022, and entitled COLLAPSIBLE SHELVING UNIT HAVING RETRACTABLE WHEELS, which is incorporated herein by reference in its entirety.

### FIELD

The present invention relates generally a shelving system and more particularly to a movable shelving unit configured to operate in two different modes of operation in order to move over a variety of ground surfaces.

### BACKGROUND

In the construction industry and in many other industries as well, moving large amounts of cargo across a variety of ground surfaces is often required. For example, a person working as a carpenter may need to move tools and supplies from a vehicle to a building interior in order to perform required indoor work. In many cases, these tools and supplies are carried in one or more toolboxes, tool organizers or shelving units, which may or may not be provided with wheels for rolling over ground surface (generally referred to herein as “shelving units”). In order to travel from the vehicle to the building interior, the person may need to traverse varied terrain (e.g., gravel, dirt, mulch, concrete, grass, etc.) along the way. This can result in debris and contaminants being collected by the person or their tools, supplies, or any shelving units brought by the person. This is especially true for any portion of the person (e.g., shoes) or the tools or supplies (e.g., wheels) that come into contact with the ground.

However, it is typically desired and considered polite not to bring contaminants, such as mud or dust, into the interior of buildings. For that reason, such a person might place disposable shoe covers (i.e., “booties”) over their shoes before entering the building. The booties can then be quickly removed when exiting the building. These booties allow a person to quickly transition from walking outdoors to walking inside, or vice versa, while avoiding or limiting tracking debris or contaminants indoors. However, a similar type of “bootie” is not available for tools and equipment that are rolled over the ground to the building and that likely collect similar debris and contaminants along the way. Additionally, conventional rolling tool organizers or shelving units are provided with only a single wheelset and are not provided with an interchangeable wheelset. As such, even if the person covers their own feet with a disposable bootie, undesirable debris and contaminants may still be brought into the building on the wheels of the equipment that accompany the person.

For these reasons, in order to avoid bringing debris or contaminants indoors on the wheels of their equipment, the person might be forced to carry their equipment and supplies by hand and/or to go through the added effort of placing a protective covering down along their walking path, including indoors and/or outdoors. Another issue with conventional shelving units is that they are provided with only a single set of wheels and those wheels are typically suited to traverse only one type of terrain, depending on their intended use. For example, large rubber wheels might be well suited for outdoor use or over rough terrain, while smaller non-marring casters might be preferred indoors over smooth ground surface. Thus, in order to move a shelving unit from outdoor to indoors, one wheelset (e.g., outdoor wheels) would need to be removed and replaced with a second wheelset (e.g., indoor casters).

Next, many trades (e.g., mechanics, carpenters, plumbers) require a large amount of large and/or bulky tools and supplies. As such, shelving units used in these trades are often large, bulky and heavy. This weight and bulk can prove problematic when transporting the shelving unit in vehicles as well as over ground surfaces. Further, the supplies and tools may fall from shelves of all sizes without proper securement. These problems are also prevalent for many other tradesman in the construction industry whose work requires various tools and supplies (e.g., plumbers, painters, masons, electricians, etc.). The same issue also impacts other non-construction industries like food service and catering, professional movers, and others that move large loads over varied terrains, including rough, outside terrain and cleaner, inside environments.

What is needed, therefore, is a shelving unit having a movable base with at least two different wheelsets to enable the shelving unit to move over at least two different types of terrain. More preferably, what is needed is a shelving unit having a movable base with at least two different wheelsets that are easily interchangeable such that the shelving unit can quickly change between two different modes of operation, depending on the wheelset being used.

### Notes on Construction

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both movable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

The term “ground surface” means any surface over which a shelving unit may be transferred, rolled, conveyed, etc., and includes surfaces of all types (e.g., dirt, concrete, tile, etc.) and all locations (e.g., indoors or outdoors).

### SUMMARY

The above and other problems are addressed by a movable base configured to move over ground surfaces in two different modes of operation. The movable base may include an enclosed housing, a first wheelset having a first pair of wheels mounted to the housing, a second wheelset having a second pair of wheels mounted to the housing, and a mode selector. Each wheel of the first wheelset may have a diameter D1 and each wheel of the second wheelset may have a diameter D2. Diameter D1 may be larger than diameter D2 in some instances or have a type of ground-contacting surface that is different from a type of ground-contacting surface of the second wheels. The first and second wheelset can each move between a respective first position wherein neither of the respective pair of wheels contact the ground surface and a second position wherein each of the respective pair of wheels can contact and are configured to move over the ground surface. The mode selector selectively converts the base between a first mode of operation and a second mode of operation. In the first mode, the first wheelset is in the first position and the second wheelset is in the second position. In the second mode, the first wheelset is in the second position and the second wheelset is in the first position. The mode selector may also be a first actuator for moving the first wheelset between the first position and the second position and a second actuator for moving the second wheelset between the first and second positions. The first and second actuators may be foot pedals protruding from a rear-facing wall of the housing. In addition, a brake may be included to restrict motion of the first or second wheelset. A third actuator, which may also protrude from the rear-facing wall of the housing, may operate the brake. In addition, a fourth actuator and a fifth actuator may be present, typically protruding from a front-facing wall of the housing. The fourth actuator moves the second wheelset between the first position and the second position. The fifth actuator operates the brake. The actuators may be disposed within an inset in a front-facing wall or a rear-facing wall of the housing such that the actuators do not extend beyond a periphery of the housing.

Also disclosed herein is a movable shelving unit configured to move over ground surfaces in two different modes of operation comprising the movable base described above and a shelving unit affixed to the movable base. The shelving unit may preferably include a shelf oriented substantially parallel to a top surface of the movable base and a first support for supporting the shelving unit vertically above the movable base. The first support includes a first end attached to the movable base and a second end attached to the shelf. The shelving unit may include a second support having a first end attached to the movable base and a second end attached to the shelf. In the case of the first and second supports, the first support may be attached to a left side of the shelf and movable base and the second support may be attached to a right side of the movable base and shelf. A side table having a first end and a second end may be attached to the first support. The first end of the side table may be pivotally attached to the first support, allowing the side table to move between a first positon wherein the panel is substantially parallel to the first support and a second position where the panel is substantially perpendicular to the first support. The side table may also be affixed to the second support.

The first support may also be in the form of a first elongate bar and a second elongate bar, each elongate bar having a first end and a second end. In addition, the shelving unit may include a second support having a third elongate bar and a fourth elongate bar, each elongate bar having a first end and a second end. In certain arrangements the first elongate bar and the second elongate bar are in parallel with the first end of each of the first elongate bar and second elongate bar rotatably attached to a left side of the base and the second end of each of the first elongate bar and the second elongate bar rotatably attached to the left side of the shelf. Similarly, the third elongate bar and the fourth elongate bar may be in parallel with the first end of each of the third elongate bar and fourth elongate bar rotatably attached to a right side of the base and the second end of each of the third elongate bar and the fourth elongate bar rotatably attached to the right side of the shelf. This arrangement allows the shelf to be movable in a vertical direction with respect to the base as the elongate bars rotate about the various attachment points while the first and second elongate bars remain in parallel and the third and fourth elongate bars remain in parallel.

Also disclosed herein is a movable shelving unit having first support, which may have a first elongate bar and a second elongate bar, the first support forming an X-shape. Each of the first and second elongate bars may have a first end and a second end. The first end of each of the first elongate bar and second elongate bar is attached to the movable base. The second end of each of the first elongate bar and second elongate bar is attached to the shelf and arranged such that the first elongate bar crosses the second elongate bar, forming the X-shape. The X-shaped first support may form a scissor lift, allowing the shelf to move vertically with respect to the base. The scissor lift is formed by a first groove in the movable base and a second groove in the shelf. The first end of the first elongate bar is rotatably mounted to the movable base and the second end is slidably mounted within the second groove. The second end of the first elongate bar may slidably move along the second groove. The first end of the second elongate bar is slidably mounted within the first groove and is configured to slide along the first groove. The second end of the second elongate bar is rotatably mounted to the shelf. A second support may be included having a third elongate bar and a fourth elongate bar, each having a respective first end and second end. A third groove may be disposed in the base and a fourth groove may be disposed in the shelf. The first end of the third elongate bar is rotatably mounted to the movable base and the second end is slidably mounted within the fourth groove. The second end of the third elongate bar may slidably move along the fourth groove. The first end of the fourth elongate bar is slidably mounted within the third groove and is configured to slide along the third groove. The second end of the fourth elongate bar is rotatably mounted to the shelf. The first support, first groove, and second groove may be disposed on the left side of the appropriate base and shelf. The second support, third groove, and fourth groove may be disposed on the right side of the appropriate base and shelf.

Finally disclosed herein is a method of transportation comprising a variety of steps. First, a movable base configured to move over ground surfaces in two different modes of operation is provided. The movable base may include a housing a first wheelset comprising a first pair of wheels mounted to the housing. The first pair of wheels may be configured to move between a first position wherein neither of the first pair of wheels contacts the ground surface and a second position wherein each of the first pair of wheels contact the ground surface. The movable base may further contain a second wheelset having a second pair of wheels mounted to the housing. The second set of wheels may be configured to move between a first position wherein neither of the second pair of wheels contacts the ground surface and a second positon wherein each of the second pair of wheels contacts the ground surface. The movable base may further contain a mode selector for selectively converting the movable base between the first mode of operation wherein the first wheelset may be in the first position and the second wheelset may be in the second position and (ii) a second mode of operation wherein the first wheelset is in the second position and the second wheelset is in the first position. Next, the first wheelset is placed in the first position and the second wheelset is placed in the first position. The movable base is then transported over a first ground surface with only the wheels of the second wheelset contacting the first ground surface. The mode selector is then used to convert the movable base from the first mode of operation to the second mode of operation. The movable base may then be transported over a second ground surface with only the wheels of the first wheelset contacting the second ground surface.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a perspective view of a movable shelving unit having a movable base and a shelving unit according to a first embodiment of the present invention;

FIG. 2 is a rear elevation view of the movable base of FIG. 1 having a first actuator being actuated for positioning first and second wheelsets in a first position;

FIG. 3 is a rear elevation view of the movable base of FIG. 1 having a second actuator being actuated for positioning the first and second wheelsets in a second position;

FIG. 4 is a side view of the movable base of FIG. 1 and a shelving using according to an alternative embodiment of the present invention, and also illustrating movement of the first and second wheelsets and also movement of a representative actuator; and

FIG. 5 is a side view of the movable base and a shelving using according to an alternative embodiment of the present invention that includes actuators on a front and rear of the housing.

### DETAILED DESCRIPTION

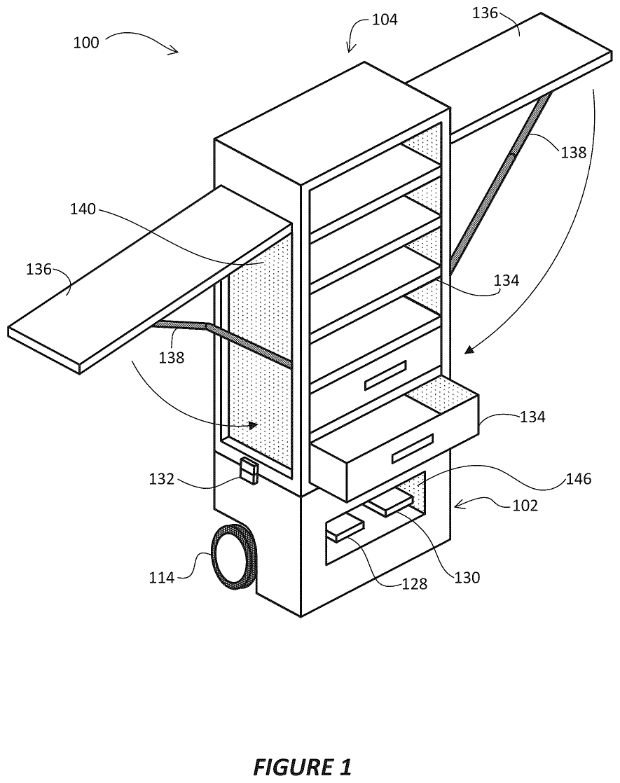

With reference to FIGS. 1-5, there is shown a movable shelving unit 100 having a movable base 102 that is provided with different wheelsets (detailed below) that enable the shelving unit to move over a variety of ground surfaces G in multiple different modes of operation. The mobile shelving unit 100 also includes a shelf 104 that is located on top of the movable base 102 and that can be used to hold tools, equipment, supplies, etc. As further discussed below, an advantage of the present design of shelving unit 100, including especially the movable base 102, is that the wheels of one wheelset may be employed in certain areas where they are well suited for use (e.g., on a rough and dirty ground surface outside of a home) and then the movable base may be quickly converted to use wheels of another wheelset that are are well suited for use in different areas (e.g., on a smooth and clean ground surface inside of a home). Advantageously, the shelving unit 100 allows a user to quickly and easily roll the shelf 104, including the tools, equipment, supplies, etc. that it carries, from one location to another on the movable base 102 and over a variety of ground surfaces G.

The base 102 preferably includes a housing 106 that has a bottom 108A and a top 108B and that, at least in certain embodiments, is partially or fully enclosed by housing walls 110 in order to hide some or all of a hollow interior 112 of the housing, where internal components, such as moving mechanisms (e.g., gears, springs, motors, hydraulics, etc.) and braking mechanisms for moving and arresting movement of the wheelsets. Preferably, the shelf 104 is removably mounted to the top 108B and is, therefore, movable with the movable base 102. The base 102 further includes a first wheelset, formed by at least a pair of first wheels 114, and a second wheelset, formed by at least a pair of second wheels 116, that are each mounted to the housing 106. In certain embodiments, different and other numbers of wheels 114 or wheels 116 may be provided.

The wheels 114, 116 of each wheelset are configured to move between a first position and a second position. When the wheels 114, 116 of one of the wheelsets is in the first position, neither of the wheels of that wheelset extend beyond the periphery of the base 102. As such, none of the wheels 114, 116 contact or can contact the ground surface G as the base is moved over the ground surface. Conversely, when the wheels 114, 116 of one of the wheelsets is in the second position, each of the wheels of that wheelset is configured to move outside of the periphery of the base 102, enabling contact with the ground surface G. The respective wheels 114, 116 are further configured to carry the base 102 as the base is moved over the ground surface. Preferably, when in the second position, wheels 114 extend rearward beyond the periphery of the base 102, allowing the wheels to contact the ground surface G and suppor thte base as the base is tilted in a rearward direction. Wheels 116, on the other hand, extend downwards from the bottom 108A and contact the ground surface G.

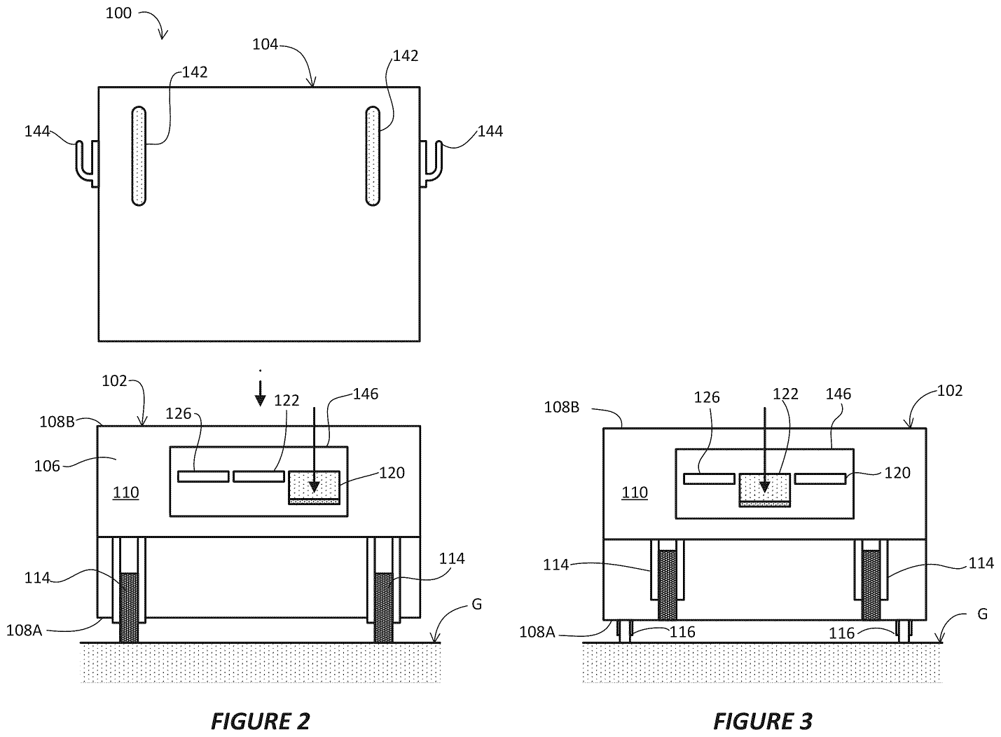

For example, in FIG. 2, first wheels 114 extend rearwards from bottom 108A and allow for contact with ground surface G and are, therefore, in the second position. The second wheels (not shown in FIG. 2) are in the first position and do not contact the ground surface G. In certain other embodiments, the first wheels 114 move in a downward direction or in a combination of downward and rearward (e.g., vertically, angled, or in a curved direction). In this case, the first wheels 114 are wide and have a large diameter, which makes them suitable for use over rough terrain, such as outdoors. On the other hand, in FIG. 3, the first wheels 114 have been retracted, are no longer able to contact the ground surface G, and are, therefore, in the first position. At the same time, second wheels 116 extend downwards from bottom 108A and contact ground surface G and are, therefore, in the second position. In this case, the second wheels 116 are smaller and are thinner and are, therefore, more appropriate for smoother surfaces such as indoors. In this case, second wheels 116 may include locking and/or spinning, non-marring casters that are suitable for indoor use. Any of wheels 114, 116 may also be unidirectional or multi-directional. Additionally, different types or sizes of wheels may be used for wheels 114 versus wheels 116. For example, in certain embodiments, wheels 114 have a diameter D1, while wheels 116 have a diameter D2. In some preferred embodiments, diameter D1 is greater than the diameter D2. Additionally, the ground-contacting surface of the wheels may vary as well. For example, since wheels 114 are intended for outdoor use, their ground-contacting surface may provide a high degree of grip (e.g. large treads) in order to remain stable on outdoor surfaces. On the other hand, since wheels 116 are intended for use indoors, their ground-contacting surface may be smooth and non-marring to provide for smooth rolling of the shelving unit 100 when indoors.

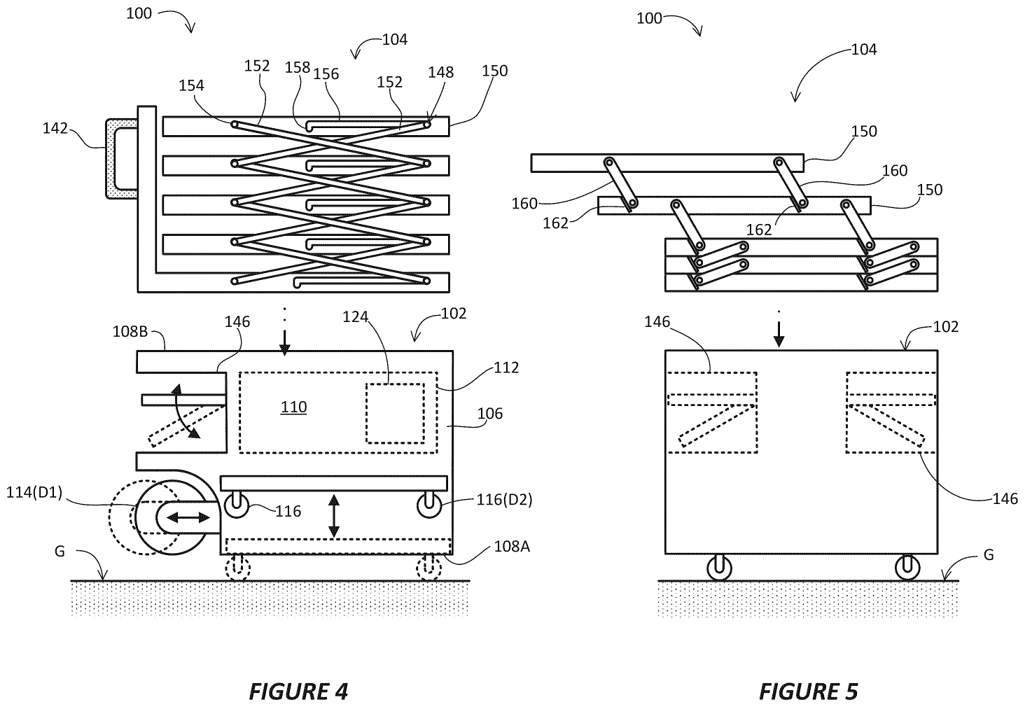

In certain embodiments, different and other numbers of wheels may be provided and the location and arrangement of the wheels may be different between wheelsets. This would allow for different functionality and methods of operating the shelving unit 100 depending on the type of wheels 114, 116 provided. For example, as shown in FIG. 4, first wheels 114 in this case include a pair of large wheels that are mounted to the housing 106. In this particular embodiment, first wheels 114 are positioned at the rear of the base 102 (i.e., the left side of base 102, as shown in FIG. 4). This positioning would enable the shelving unit 100 to be tilted onto and supported by these large first wheels 114 in a manner similar to a hand truck or dolly as the first wheels are in a second position. This arrangement would, therefore, be beneficial in quickly transporting the shelving unit 100 over rough terrain (e.g., outdoors). Then, as shown in FIG. 5, a total of four second wheels 116 (of which only two are shown) are placed along the bottom 108A of the housing 106. In this case, second wheels 116 are small, non-marring spinning and/or locking casters that are ideal for indoor use. By positioning, several second wheels 116 along the bottom 108A, the shelving unit 100 may be tilted down from the large first wheels 114 onto the smaller second wheels at the transition between an outdoors walkway and an indoors floor. Of course, it is anticipated that different numbers, arrangements, or positions of wheels may be provided. For example, second wheels 116 are shown positioned outside of first wheels 114, however, in certain embodiments, first wheels 114 are inboard of or coplanar with second wheels 116. The term “wheel”, as used herein, should be construed broadly to include any mechanism that will permit the base 102 to be conveyed over a ground surface G.

As noted above, shelving unit 100 is preferably configured to move over ground surfaces G in two different modes of operation, including a first mode of operation and a second mode of operation. In the first mode of operation, the first wheelset is in the first position and the second wheelset is in the second position. Then, in the second mode of operation, the first wheelset is in the second position and the second wheelset is in the first position. Preferably, the movable base 102 includes a mode selector for selectively converting the movable base between the first mode of operation and the second mode of operation. In certain embodiments, the mode selector comprises one or more actuators for activating or deactivating wheels. For example, in the illustrated embodiment, a first actuator 120 moves the first wheels 114 between the first position and the second position and vice versa, and then a second actuator 122 moves the second wheels 116 from the first position to the second position and vice versa. In certain embodiments, the first actuator 120 and the second actuator 122 are foot pedals protruding from an exterior of the housing 106. However, other mechanisms, including other mechanical and/or electrical controls, may be used as actuators 120 and 122 in place of foot pedals. For example, actuators 120 and 122 may include buttons paired to electronic lifters. In certain embodiments, actuators 120 and 122 extend from a rear-facing housing wall of the enclosed housing 106. However, in other cases including in the illustrated embodiments, actuators 120, 122 are located within an inset 146 formed in the housing 106 such that the actuators do not extend beyond the periphery of the housing. Additionally, in preferred embodiments, wheels 114, 116 are also located entirely within the periphery of the housing 106 in both the first and second positions.

In certain embodiments, the movable base 102 further comprises a brake (represented by box 124, shown in FIG. 4) that is preferably disposed within the housing 106 that slows and stops movement of either a single wheelset or multiple wheelsets, including one or both of wheels 114 and wheels 116. Brake 124 may comprise any mechanical, electrical or other means capable of slowing and/or stopping movement of the wheelsets when desired. In certain embodiments, brake 124 is operated using a third actuator 126 that, in certain embodiments, is provided in the form of a foot pedal protruding from the exterior of the housing 106, including within inset 146. In one preferred embodiment, as the third actuator 126 is pressed, a plurality of rubber pads moves to contact one or both of wheels 114 and wheels 116 and is held in place with a spring. The contact is maintained until the actuator 126 is pressed again, releasing the spring tension.

In certain embodiments, base 102 further includes additional actuators, such as fourth actuator 128 and fifth actuator 130 (shown in FIG. 1), to control certain aspects of the shelving unit 100 and each additional actuator may serve any function of first actuator 120, second actuator 122, or third actuator 126, or other functions. In the illustrated embodiment, like the second actuator 122, the fourth actuator 128 is configured to move the second wheels 116 between the first position and the second position. Next, like the third actuator 126, the fifth actuator 130 activates and deactivates the brake 124. These additional actuators 128, 130 are preferably mounted to and extend away from a different position or opposite side of the housing 106 compared to the actuators discussed previously in order to provide increased ease of access to actuators for carrying out those functions. For example, in preferred embodiments, the fourth actuator 128 and fifth actuator 130 may each be mounted to a forward-facing housing wall. Advantageously, the fourth actuator 128 and fifth actuator 130 allow a user to change the position of the second wheels and to operate the brake 124 from the front of the shelving unit 100. Having actuators located on opposing or different sides of the shelving unit 100 that serve the same function is especially useful in cases where one portion of the shelving unit is inaccessible. For example, when storing the device, a user may wish to position the shelving unit 100 such that its rear-facing wall is located adjacent a wall or corner, which would make actuators 120 and 122 inaccessible. However, by providing additional actuators 128 and 130 (or additional or other actuators), the user can still operate wheels 114, 116 and/or brake 124 from a different side of the shelving unit 100. Preferably, the additional actuator 128, 130 are also located within an inset 146 that is sized and configured to allow them to be operated by the user while not extending beyond the periphery of the housing 106.

Next, shelf 104 is preferably removably and interchangeably mounted to the base 102, such as by using latching means 132 (FIG. 1). In other embodiments, the shelf 104 is fixedly attached to the base 102 via bolts, screws, welding, or other appropriate attachment means. Further, in certain preferred embodiments, the shelf 104 and the base 102 are a unitary construction. As the term is used here, unless explicitly limited or limited through context, “shelf” should be interpreted broadly to include any apparatus having means for removably and interchangeably mounting to base 102. As non-limiting examples, shelf 104 includes cargo-holding devices such as toolboxes, catering hot boxes, organizers, coolers, and the like. Accordingly, a benefit of the present invention is that the base 102 is universal and any type of device having an appropriate latching or connecting interface may be used as a shelf 104. This would allow, for example, a single base 102 to be used in connection with multiple different cargo-storing or other devices (each functioning as a separate shelf 104) that store different tools, supplies, etc. needed by the user.

In FIG. 1, shelf 104 resembles a bookcase or a chest of drawers that preferably includes shelves/drawers 134 and a pair of working side tables 136 that are pivotally mounted to the outside of shelf 104. Collapsible supports 138 are mounted to each of the side tables 136, which allow the side tables to be lifted and locked in a horizontal “use” position and also to be collapsed and locked in a vertical “storage” position. In preferred embodiments, when in the stored position, the side tables 136 are stored within recesses 140 formed in side walls of the shelf (only one is shown, but both recesses are identical) such that the side tables does not extend beyond the periphery of the base 102 or shelf 104.

As shown in FIGS. 2 and 4, one or more handles 142 are preferably mounted on a rear-facing wall of the shelf 104. These handles 142 may be grasped by a user and used to tilt the shelving unit 100 forwards or backwards when operating as a hand truck or dolly. The shelf 104 may also include attachment-points 144 for securing the shelving unit to a variety of fixtures or walls. These attachment-points 144 may take the form of hooks, anchors, magnets, suction cups, or the like.

The shelf in FIGS. 2 and 4 takes the form of a collapsible shelf employing scissor hinges 148 for use in raising and lowering a plurality of movable shelves 150 that form the shelf. In this case, each scissor hinge 148 includes a pair of arms 152 that are each rotatably connected between an adjacent pair of movable shelves 150. A first end of each arm 152 is fixedly located (but rotatable) at an attachment point 154. An opposite second end of each arm is slidably located within a slot 156 that preferably has at least one locking notch 158 for releasably fixing the second end of the arm 152 at a selected location along the slot. As shelves 150 are raised, the first end of each arm 152 rotates within the attachment point 154 while the second end of each arm slides along the slot 156. Once the shelf 150 has reached the desired height, the second end of the arm 152 may be located within a nearby notch 158 (if multiple notches are provided). The overall height of the shelf 104 can, therefore, be increased or decreased as desired by adding or removing shelves 150. In certain embodiments of the present invention, the shelf 104 extends to a height of up to 6 feet. The shelf in FIG. 5 takes the form of a collapsible shelf employing cantilevered hinges 160 for use in raising and lowering a plurality of movable shelves 150 that form the shelf. A stop 162, such as a pin, spring detent, etc., prevents over-rotation of the cantilevered hinges 160 beyond a desired position.

In operation, a user will typically approach the movable base 102 from the rear and the first wheelset and the second wheelset are each in their respective first positions. The user will then press the first actuator 120 in order to move the first wheels 114 from the first position to the second position. The user will then grasp the handles 142 and tilt the movable base 102 and shelf 104 rearward onto first wheels 114 and lifting the base 102 off the ground and allowing for transportation via the first wheelset like a hand truck or dolly. Again, this mode of operation will allow for travel of the shelving unit 100 over rough or uneven terrain, such as outside. Then, as the shelving unit approaches a different type of ground surface, such as a front door, the user tilts the shelf 104 and base 102 forward such that a portion of the movable base or the second wheel contact the ground surface. For example, the user may actuate the second actuator in order to move the second wheels 116 from the first (stored) position to the second (use) position before lowering the shelving unit 100. Preferably, wheels 114 and 116 are sized and positioned such that both may be positioned in the use position to allow transitioning between the wheelsets while at least one wheelset maintains contact with the ground surface G, as shown by dashed lines in FIG. 4. This would allow the user to easily tilt the shelving unit 100 onto the second wheels 116 and to then move the first wheels 114 from the second (use) position to the first (stored) position while the shelving unit is securely standing upright on the ground surface G. Not only do the separate wheelsets allow for easier transportation over varied surfaces but switching between the first wheelset and the second wheelset prevents the unwanted transfer of contaminants from one location to another location (e.g., outside versus inside). For example, if the outside surface is dirt, any dirt contained on the first wheelset will not be present on the second wheelset.

What is claimed is:

1. A movable base configured to move over ground surfaces in two different modes of operation, the movable base comprising:
a housing;
a first wheelset comprising a pair of first wheels mounted to the housing and configured to be moved between (i) a first position wherein neither of the first wheels contacts the ground surface as the movable base is moved over the ground surface and (ii) a second position wherein each of the first wheels is configured to contact the ground surface and wherein the first wheels are configured to carry the movable base as the movable base is moved over the ground surface;
a second wheelset comprising a pair of second wheels mounted to the housing and configured to be moved between (i) a first position wherein neither of the second wheels contacts the ground surface as the movable base is moved over the ground surface and (ii) a second position wherein each of the second wheels is configured to contact the ground surface and wherein the second wheels are configured to carry the movable base as the movable base is moved over the ground surface; and
a mode selector for selectively converting the movable base between (i) a first mode of operation wherein the first wheelset is in the first position and the second wheelset is in the second position and (ii) a second mode of operation wherein the first wheelset is in the second position and the second wheelset is in the first position.

2. The movable base of claim 1 wherein the first wheels have a size or a type of ground-contacting surface that is different from a size or a type of ground-contacting surface of the second wheels.

3. The movable base of claim 2 wherein each first wheel has a diameter D1 and each second wheel has a diameter D2, wherein diameter D1 is larger than diameter D2.

4. The movable base of claim 1 wherein the mode selector comprises a first actuator configured to move the first wheelset between the first position and the second position.

5. The movable base of claim 4 wherein the mode selector further comprises a second actuator configured to move the second wheelset between the first position and the second position.

6. The movable base of claim 1 further comprising a brake for reducing movement of at least one of the pair of first wheels of or the pair of second wheels.

7. The movable base of claim 6 further comprising a third actuator configured to activate and to deactivate the brake.

8. The movable base of claim 7 wherein the mode selector comprises:
a first actuator configured to move the first wheelset between the first position and the second position; and
a second actuator configured to move the second wheelset between the first position and the second position.

9. The movable base of claim 8 wherein the first actuator, the second actuator, and the third actuator each comprise a foot pedal extending outwards from the housing.

10. The movable base of claim 9 further comprising:
a fourth actuator that is configured to move the second wheelset between the first position and the second position; and
a fifth actuator that is configured to activate the brake so as to reduce movement of the at least one of the pair of wheels of first wheelset or the second wheelset and further configured to deactivate the brake,
wherein the first actuator, the second actuator, and the third actuator each protrude from a rear-facing wall of the housing, and
wherein the fourth actuator and the fifth actuators each protrude from a front-facing wall of the housing.

11. The movable base of claim 9 further comprising:
a fourth actuator that is configured to move the second wheelset between the first position and the second position; and
a fifth actuator that is configured to activate the brake so as to reduce movement of the at least one of the pair of wheels of first wheelset or the second wheelset and further configured to deactivate the brake,
wherein the first actuator, the second actuator, and the third actuator each are disposed in an inset in a rear-facing wall of the housing, and
wherein the fourth actuator and the fifth actuators each are disposed in an inset in a front-facing wall of the housing.

12. A movable shelving unit configured to move over ground surfaces in two different modes of operation, the movable shelving unit comprising:
a movable base having:
a housing;
a first wheelset comprising a pair of first wheels mounted to the housing and configured to be moved between (i) a first position wherein neither of the first wheels contacts the ground surface as the movable base is moved over the ground surface and (ii) a second position wherein each of the first wheels is configured to contact the ground surface and wherein the first wheels are configured to carry the movable base as the movable base is moved over the ground surface;
a second wheelset comprising a pair of second wheels mounted to the housing and configured to be moved between (i) a first position wherein neither of the second wheels contacts the ground surface as the movable base is moved over the ground surface and (ii) a second position wherein each of the second wheels is configured to contact the ground surface and wherein the second wheels are configured to carry the movable base as the movable base is moved over the ground surface; and
a mode selector for selectively converting the movable base between (i) a first mode of operation wherein the first wheelset is in the first position and the second wheelset is in the second position and (ii) a second mode of operation wherein the first wheelset is in the second position and the second wheelset is in the first position; and
a shelving unit affixed to the movable base, the shelving unit having:
a shelf oriented substantially parallel to a top surface of the movable base; and
a first support for supporting the shelf vertically above the movable base, the first support having a first end attached to the movable base and a second end attached to the shelf.

13. The movable shelving unit of claim 12 further comprising:
a second support for supporting the shelf vertically above the movable base, the second support having a first end attached to the movable base and a second end attached to the shelf unit; and
a side table having a first end and a second end, the first end being pivotally attached to one of first support or the second support,
wherein the first support is attached between a left side of the movable base and shelf unit and the second support is attached between a right side of the movable base and shelf, and
wherein the side table can pivot between a first position which is substantially parallel to the first support or the second support and a second position which is substantially perpendicular to the first support or the second support.

14. The movable shelving unit of claim 12 further comprising a second support for supporting the shelf vertically above the movable base,
wherein the first support comprises:
a first elongate bar having a first end and a second end; and
a second elongate bar having a first end and a second end,
wherein the second support comprises:
a third elongate bar having a first end and a second end; and
a fourth elongate bar having a first end and a second end,
wherein the first end of each of the first elongate bar and second elongate bar is rotatably attached to a left side of the base and the second end of each of the first elongate bar and the second elongate bar is rotatably attached to a left side of the shelf, such that the first elongate bar and the second elongate bar are parallel,
wherein the first end of each of the third elongate bar and fourth elongate bar is rotatably attached to a right side of the base and the second end of each of the third elongate bar and the fourth elongate bar is rotatably attached to a right side of the shelving unit, such that the third elongate bar and the fourth elongate bar are parallel, and
wherein the shelf is movable in a vertical direction with respect to the base.

15. The movable shelving unit of claim 12 wherein the first support comprises:
a first elongate bar having a first end and a second end; and
a second elongate bar having a first end and a second end,
wherein the first end of each of the first elongate bar and second elongate bar is attached to the base and the second end of each of the first elongate bar and second elongate bar is attached to the shelf, such that the first elongate bar crosses the second elongate bar and the support forms an X-shape.

16. The movable shelving unit of claim 15 wherein a scissor lift is formed by the first support to enable the shelving unit to be moved vertically with respect to the movable base from a closed position to an open position, the scissor lift having:
a first groove disposed in the movable base; and
a second groove disposed in the shelf,
wherein the first end of the first elongate bar is rotatably mounted to the movable base and the second end of the first elongate bar is slidably mounted within and is configured to slide along the second groove, and
wherein the first end of the second elongate bar is slidably mounted within and is configured to slide along the first groove the and second end of the second elongate bar is rotatably mounted to the shelf.

17. The movable shelving unit of claim 16 wherein the scissor lift includes a second support having:
a third elongate bar having a first end and a second end;
a fourth elongate bar having a first end and a second end;
a third groove disposed in the base; and
a fourth groove disposed in the shelf,
wherein the first end of each of the third elongate bar and fourth elongate bar is attached to the base and the second end of each of the third elongate bar and fourth elongate bar is attached to the shelving unit, such that the third elongate bar crosses the fourth elongate bar and the second support forms an X-shape,
wherein the first end of the third elongate bar is rotatably mounted to the movable base and the second end of the third elongate bar is slidably mounted within and is configured to slide along the fourth groove, and
wherein the first end of the fourth elongate bar is slidably mounted within and is configured to slide along the third groove and the second end of the fourth elongate bar is rotatably mounted to the shelving unit.

18. The movable shelving unit of claim 17 wherein the first support is attached between a left side of the movable base and a left side of the shelf and the second support is attached between a right side of the movable base and a right side of the shelf.

19. The movable shelving unit of claim 18 wherein the movable base further comprises a brake for reducing movement of at least one of the pair of first wheels of or the pair of second wheels.

20. A method of transportation comprising the steps of:
providing a movable base configured to move over ground surfaces in two different modes of operation, the movable base including:
a housing;
a first wheelset comprising a first pair of wheels mounted to the housing and configured to be moved between (i) a first position wherein neither of the first pair of wheels contacts the ground surface as the movable base is moved over the ground surface and (ii) a second position wherein each of the first pair of wheels is configured to contact the ground surface and wherein the first pair of wheels is configured to carry the movable base as the movable base is moved over the ground surface;
a second wheelset comprising a second pair of wheels mounted to the housing and configured to be moved between (i) a first position wherein neither of the second pair of wheels contacts the ground surface and (ii) a second position wherein each of the second pair of wheels is configured to contact the ground surface and wherein the second pair of wheels is configured to carry the movable base as the movable base is moved over the ground surface; and
a mode selector for selectively converting the movable base between (i) a first mode of operation wherein the first wheelset is in the first position and the second wheelset is in the second position and (ii) a second mode of operation wherein the first wheelset is in the second position and the second wheelset is in the first position,
with the first wheelset in the first position and the second wheelset in the second position, transporting the movable base over a first ground surface with only the wheels of the second wheelset in contact with the first ground surface;
using the mode selector, converting the movable base from the first mode of operation to the second mode operation; and
with the first wheelset in the second position and the second wheelset in the first position, transporting the movable base over a second ground surface with only the wheels of the first wheelset in contact with the second ground surface.
